(19) United States
(12) Patent Application Publication
(10) Pub. No.: US 2018/0078449 A1
(43) Pub. Date: Mar. 22, 2018

(54) Driveshaft Personal Massager and Method of Massage

(71) Applicant: Perfect Fit Brand, Inc., Boca Raton, FL (US)

(72) Inventor: Stephen Callow, Fort Lauderdale, FL (US)

(73) Assignee: Perfect Fit Brand, Inc., Boca Raton, FL (US)

(21) Appl. No.: 15/272,490

(22) Filed: Sep. 22, 2016

(51) Int. Cl. A61H 23/02; A61H 19/00

(52) U.S. Cl. CPC A61H 23/0263; A61H 19/00

(57) ABSTRACT

A driveshaft personal massager, comprising: a base unit; and, an extended driveshaft, wherein the extended driveshaft enables the waterproof base unit to use a motor to power low cost inter-changeable applicator modules containing various stimulating effects is used for new, improved, stimulating, and more precise stimulation and massage.

A portion of the disclosure of this patent document contains material which is subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### CROSS-REFERENCE TO RELATED APPLICATIONS

Not applicable

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

The invention broadly relates to personal massagers, more specifically to personal massagers with extended and flexible driveshafts and related methods of massage.

### Description of the Related Art

Generally, a personal massager is a device used for self-stimulation or the stimulation of others. It is used in therapeutic, and erotic massages.

There is art that is helpful for background information. One of the most legendary personal massagers of all time is the Hitachi Magic Wand (HMW). Since the introduction of the HMW, the HMW quickly became known by some as one of the most powerful and stimulating personal massagers on the market. However, while obtaining much public praise, the HMW has many known defects, for example, amongst other things it is: of limited portability; of limited water-safety; bulky; noisy; expensive to replace, etc. Consequently, various inventors and innovators have sought to improve the art by proposing solutions to various problems inherent in the HMW design and the designs of other personal massagers.

For example, Murison Bruce, Methods and Devices Relating to Vibratory Impact Adult Devices, U.S. Pub. No. US20160015596 (published Jan. 21, 2016) (incorporated herein by reference) shows the desire for the use of small high efficiency motors in order to produce large amounts of power must be operated such that the motors are running at high speed outside the desired vibration range for sexual stimulation. According to Murison designs allowing for the appropriate gearing to allow heavy weights to be spun with small diameter and high efficiency whilst not increasing the outer diameter of an adult device are disclosed. Murison references devices that provide high impact (amplitude) vibration in a range of physical geometries compatible with providing internal and/or external stimulation which (according to Murison) can also be offered at low cost and/or low manufacturing cost with extended operating life.

Spietz Lafe, High Torque Personal Massager, U.S. Pub. No. US20140357944 (published Dec. 4, 2014) (incorporated herein by reference) generally describes personal massagers including a rotational drive, a mechanical transformer coupled to the rotational drive and which transforms a rotational output of the rotational drive to provide an output driveshaft having increased torque relative to the rotational output of the rotational drive, a mass coupled off-center to the output driveshaft, and a housing within which the rotational drive, mechanical transformer, and mass are disposed and which includes space for rotational movement of the mass by the output driveshaft, wherein the rotational movement of the mass imparts an oscillating motion to at least a portion of the housing.

Topolovac Michael; Wood Edwin; Murphy Andrew; Chang Tian Yi; Hjartar Kristrun, Vibratory actuator and device for sexual, U.S. Pat. No. 9,144,531 (issued Sep. 29, 2015) (incorporated herein by reference) teach a variation of a device for sexual stimulation that includes: an interaction module, a power module, and a control module. The interaction module includes a housing, a female power port supported by the housing, and a first and a second vibratory actuator coupled to the female power port, isolated from the housing, and supported by the housing. The power module includes a battery coupled to a male power port. The male power port is configurable between: a first configuration in which the male power port transiently couples to an external power source to charge the battery; and a second configuration in which the male power port transiently retains the interaction module and powers the vibratory actuators to generate haptic vibratory stimulation. The control module configured to control vibratory magnitude settings and vibratory pattern settings of the vibratory actuators based upon inputs at input regions.

Smith Walton, F.; Yakos David; Larimer Randy Device and method for stimulating the Meibomian glands of the eyelid (Jul. 23, 2013) (incorporated herein by reference) describes a machine for stimulating the meibomian glands of the eyelid comprising: a handle; a head that is non-removable and integral to the handle, the head comprising an eyepiece that oscillates to provide a massaging action to an eyelid and that comprises a front end that is concave in shape to fit over an eyelid; a heater located inside of the eyepiece; a temperature sensor located inside of the eyepiece, wherein the temperature sensor causes the eyepiece to heat to a predetermined temperature and then stop heating; and a charging base that supplies power to a motor that causes the eyepiece to oscillate, wherein the motor comprises a motor shaft. A method of applying heat and massaging action to the eyelid at the same time.

Matoba Denki Seisakusho; Toshio Hirosawa, Flexible Massage Apparatus (CN Pub. No. CN102949283) (published Mar. 6, 2013) (incorporated herein by reference) identifies the need for a flexible massaging apparatus which enables massaging a desired site such as a shoulder, a neck, a back, a hip, a lower site under an arm, by holding it with easy operation and adjusts the pressure strength during the application of the pressure strength by easy operation to a body site to be massaged. It purposes a solution where a plurality of vibrators are mounted while a pair of bearing support parts is formed at the inside between openings formed at both sides of each vibrator, and an unbalancer is mounted across a pair of bearing support parts provided at each of the bearing support parts, and a bearing part is coaxially arranged at the unbalancer and both sides of them and coupled between each vibrator with a flexible driveshaft while the end part of the protective tube of the flexible driveshaft is bound to the opening of each vibrator, and the one end of whole length of the flexible driveshaft is rotatably connected to a handle member while the other end of whole length of the flexible driveshaft is connected to a motor contained in a combined case for the handle.

Levy David, Sexual stimulation devices and methods U.S. Pat. No. 8,647,255 (issued Feb. 11, 2014) and related/similar disclosures U.S. Pat. No. 9,107,797; US 2013/0,281,776; US 2015/0,351,998 (collectively incorporated herein by reference) each teach machines and methods that provide varied and dynamically controllable sensations, both directly under manual control of the user and indirect electronic control, and in such a way as to provide sensations to specific regions of the sexual organs.

As can be derived from the variety of devices for personal massagers, many means have been contemplated to accomplish the desired ends, lower cost, more powerful, versatile massaging systems.

### SUMMARY OF THE INVENTION

The present invention overcomes many of the problems with the prior art by utilizing extended and flexible driveshafts and interchangeable applicator modules. The inventor has found that extended and flexible driveshafts have very significant advantages over the prior art. In particular advantages are significant, when a personal massager utilizes a power source containing base unit and extended and flexible driveshafts with vibration dampening grips, user controls and alternative massaging parts. The invention provides for parts reuse, lower cost manufacturing and improved: amplitude, frequency, power, control, comfort, and fit. It reduces vibration in the grip and interference in the applicator module while providing improved safety, ergonomics and function by distancing the motor and power source from the application site. The enables the applicator module and any associated grip to be lighter weight and have greater control without interference from the motor or the power source in the provided stimulating effects. E.g. vibration, temperature and sound.

Although the invention is illustrated and described herein as embodied as a driveshaft personal massager, the invention is not limited to the details shown because various modifications and structural changes may be made without departing from the invention and the equivalents of the claims. However, the construction and method of operation of the invention together with additional objects and advantages thereof will be best understood from the following description of specific embodiments when read in connection with the accompanying drawings.

### BRIEF DESCRIPTION OF THE DRAWINGS

Features and advantages of the present invention will become apparent to those skilled in the art from the following description with reference to the drawings.

FIG. 1 depicts a general view of a driveshaft personal massager.

FIG. 2 depicts an alternative and cut away view of the driveshaft personal massager of FIG. 1.

FIG. 3 depicts an alternative embodiment of the present invention.

FIG. 4 depicts an alternative and cut away view of the driveshaft personal massager of FIG. 3.

FIG. 5 depicts a “ben wa” type attachment of the present invention.

FIG. 6 depicts an alternative cut away view of a “ben wa” type attachment of FIG. 5.

FIG. 7 depicts a phallic type attachment of the present invention.

FIG. 8 depicts an alternative and cut away view of the phallic type attachment of FIG. 7.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

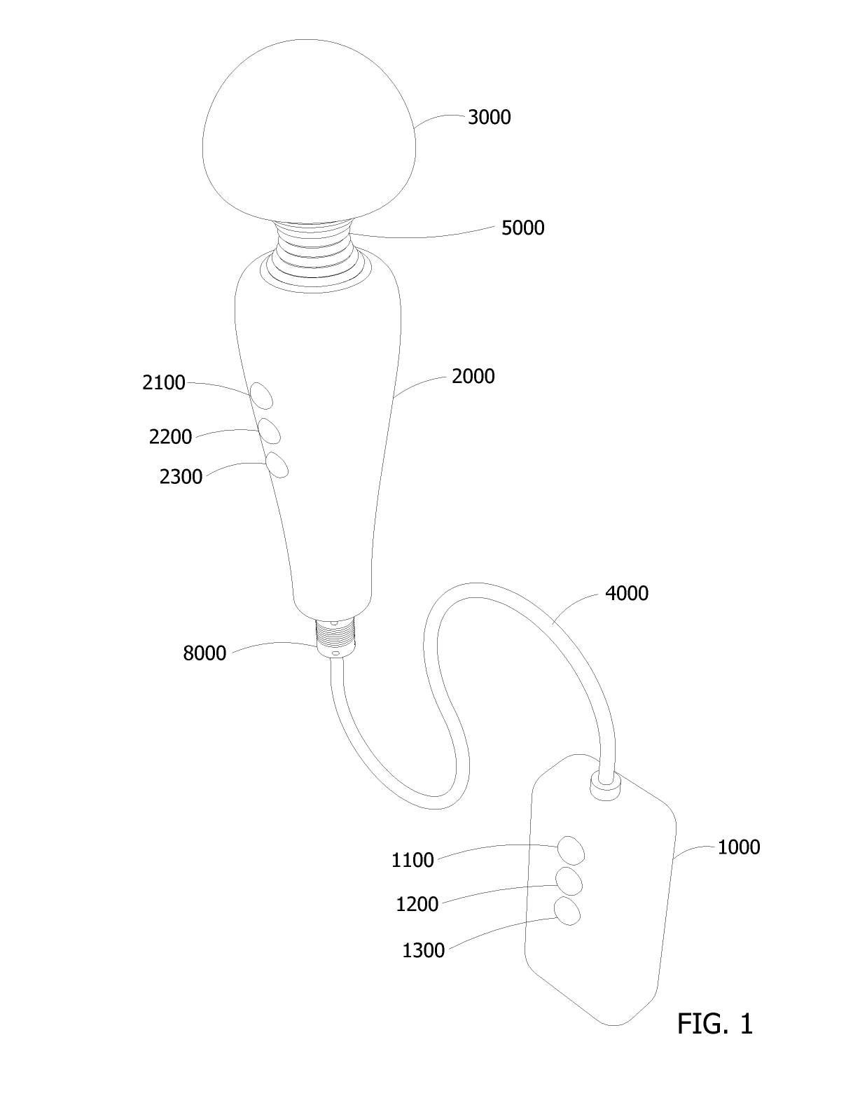

Adverting now to the figures, FIG. 1 depicts a general view of a driveshaft personal massager. The personal massager has an applicator module 3000 separated from an easy grip anti-vibration handle 2000 by a spring enclosed flexible driveshaft 5000. The anti-vibration handle includes circuitry connected to multiple grip controls 2100, 2200, and 2300. The grip controls 2100, 2200 and 2300 are generally buttons, but dials, switches, joysticks, artificial/tactile interfaces, and other controls are also used. Although the figures depict only three grip controls, some embodiments use more and some less. The controls are configurable and control things such as frequency, amplitude, pulsation, time, temperature, sound, volume, mode/function etc. Extending below the ergonomic grip of the anti-vibration handle is a flexible driveshaft 4000. The flexible driveshaft 4000 is coupled to the base unit 1000. The flexible driveshaft transmits rotary motion much like a solid steel or other more rigid shaft. The flexible driveshaft is capable of being routed over, under, and around obstacles that make using a solid shaft impractical.

Generally, the flexible driveshaft includes a rotating shaft (also known as a core) with metal end fittings for attachment to mating parts. A protective outer casing or liner is used when necessary. The protective outer casing or liner has its own fittings, such as ferrules, that keep the protective outer casing stationary during use. The flexible driveshaft is usually at least six inches long, but additional benefits are obtained from longer shafts greater than two and from three to sixteen feet. Longer driveshafts may be used depending on the application, but in many situations the ideal length is long enough to keep the base unit put away and/or out of sight such as under a bed or outside of a shower/bathtub while allowing for compact easy storage when not in use. As depicted, the base unit includes multiple base controls 1100, 1200 and 1300. An additional coupling anti-vibration grip 8000 covers the driveshaft between the applicator module.

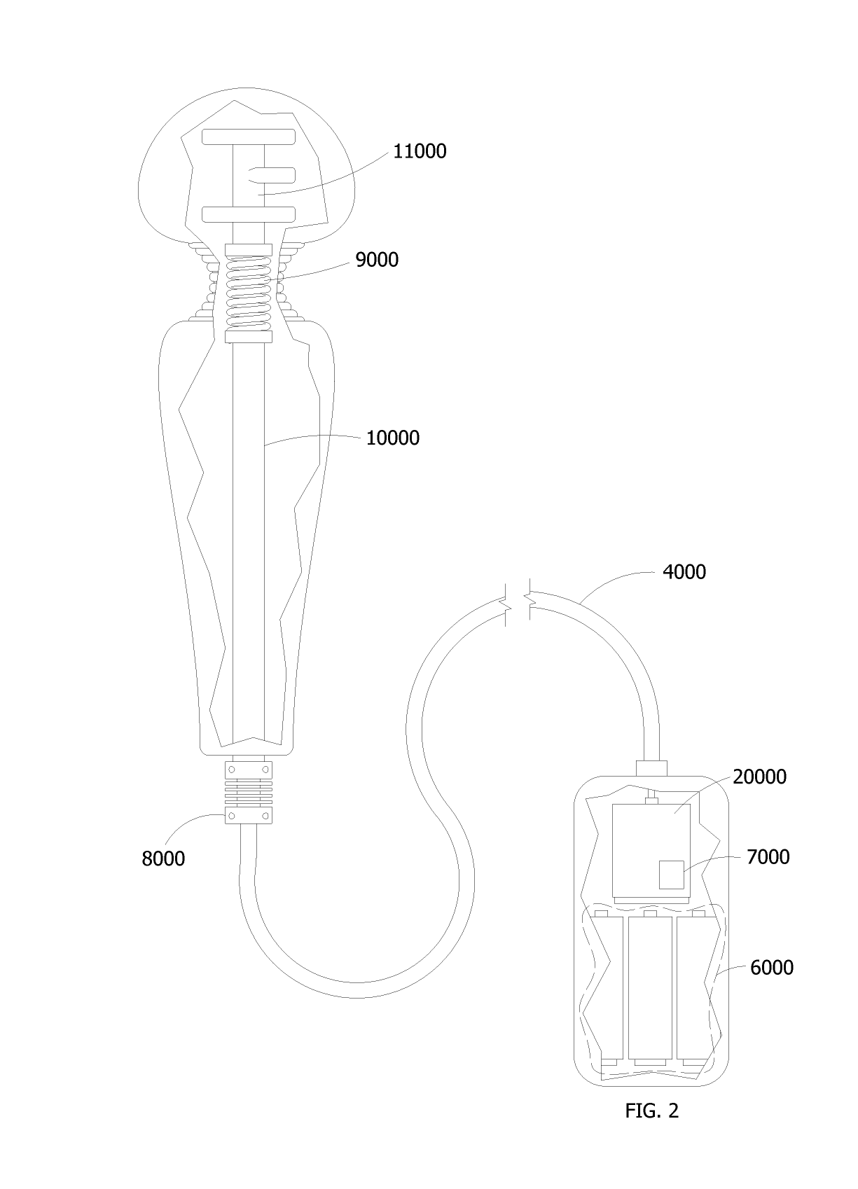

FIG. 2 illustrates a cut-away of the applicator module, the anti-vibration housing and the base unit. Contained within the base unit is processing module 7000 and battery module 6000. Battery module 6000 is enabled to comprise one or more battery/power cells. The battery/power source powers a motor 20000 inside the base unit. The motor 20000 causes the core of the flexible driveshaft to rotate. The rotation from the driveshaft causes module within the applicator module 11000 to rotate. Spring 9000 provides additional dampening effects, while vibration and oscillating movement is generated in the applicator module. Rigid driveshaft 10000 is located within the vibration reducing housing. The vibration reduction housing uses dampening materials such as rubbers, plastics, foams, springs, bushings and sponges to reduce vibration. However, a flexible driveshaft may be substituted for rigid driveshaft 10000 while still practicing the invention described herein. In fact, in some embodiments the flexible driveshaft 4000 continues through the vibration reducing housing. In addition to the casing around the core of the flexible driveshaft 4000 the vibration reduction housing provides additional comfort with better grip and less vibration than the case of the flexible driveshaft 4000.

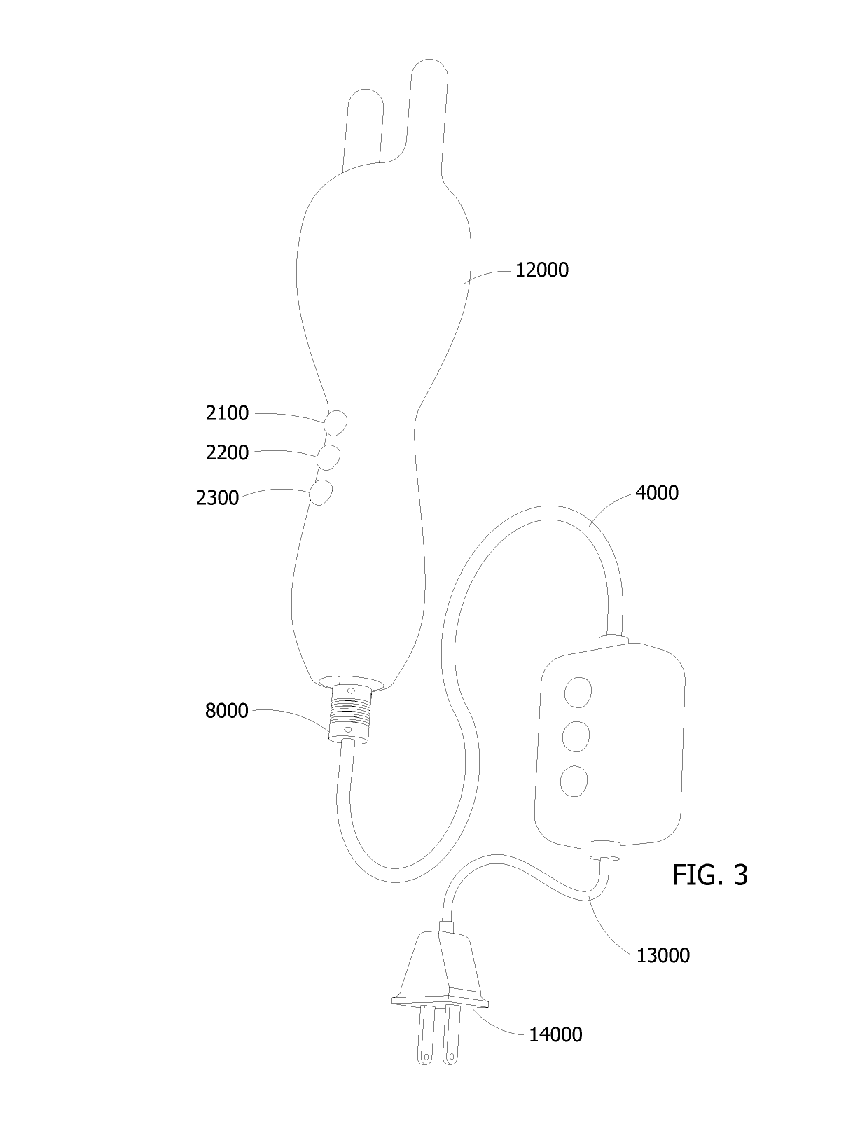

FIG. 3 illustrates an alternative embodiment where the applicator module is of a different shape (rabbit ears) 12000, but operates upon a similar principal. The energy produced in the base unit 1000 is transferred to the applicator module 12000 through a flexible driveshaft. In this example, the unit is powered by an AC power cord 13000 to a standard outlet plug 14000. However, DC current and/or other power sources are in some circumstances preferred. Batteries in the base unit 1000 make the base unit 1000 more portable and safer for use in or near wet environments, such as the shower, bath, pool, lake, ocean, rain, snow and spa.

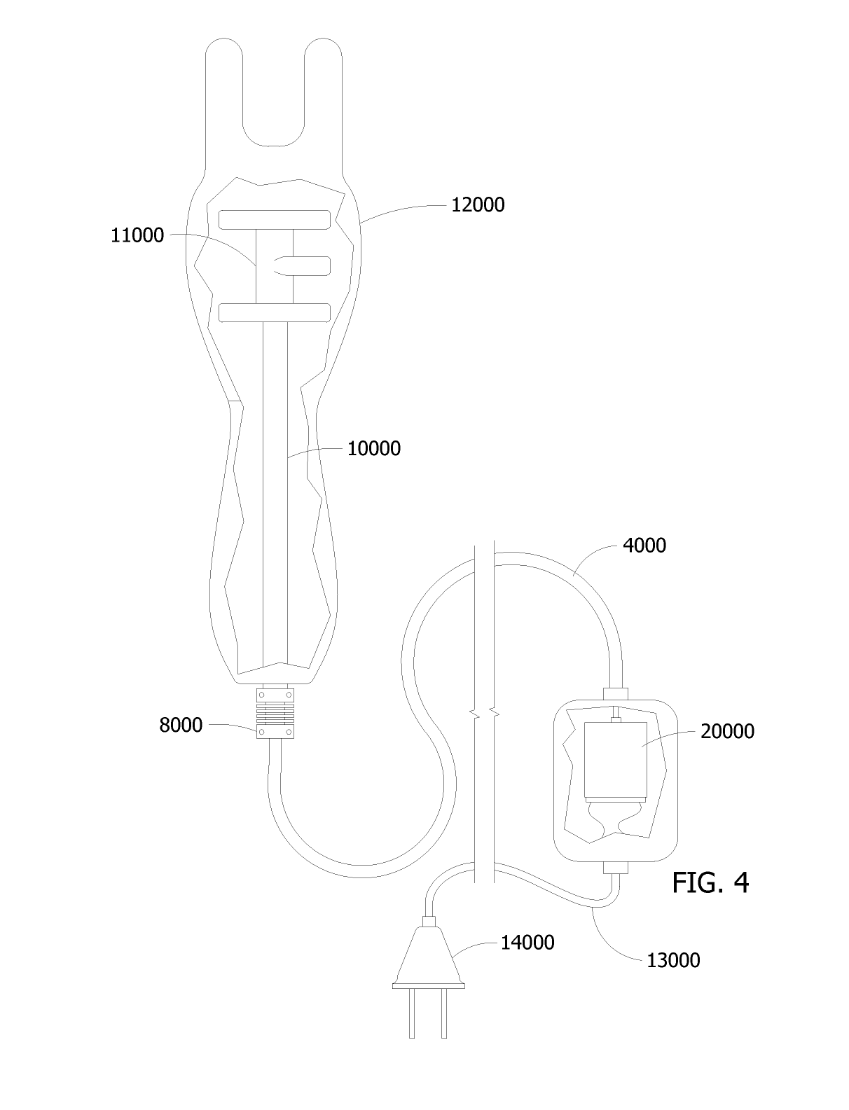

FIG. 4 illustrates a cut away of the base unit 1000 and rabbit ears applicator module shown in FIG. 3. Inside the base unit is a motor 20000 which drives the flexible driveshaft 4000 that moves and/or energizes the applicator module 12000 and/or parts therein 11000.

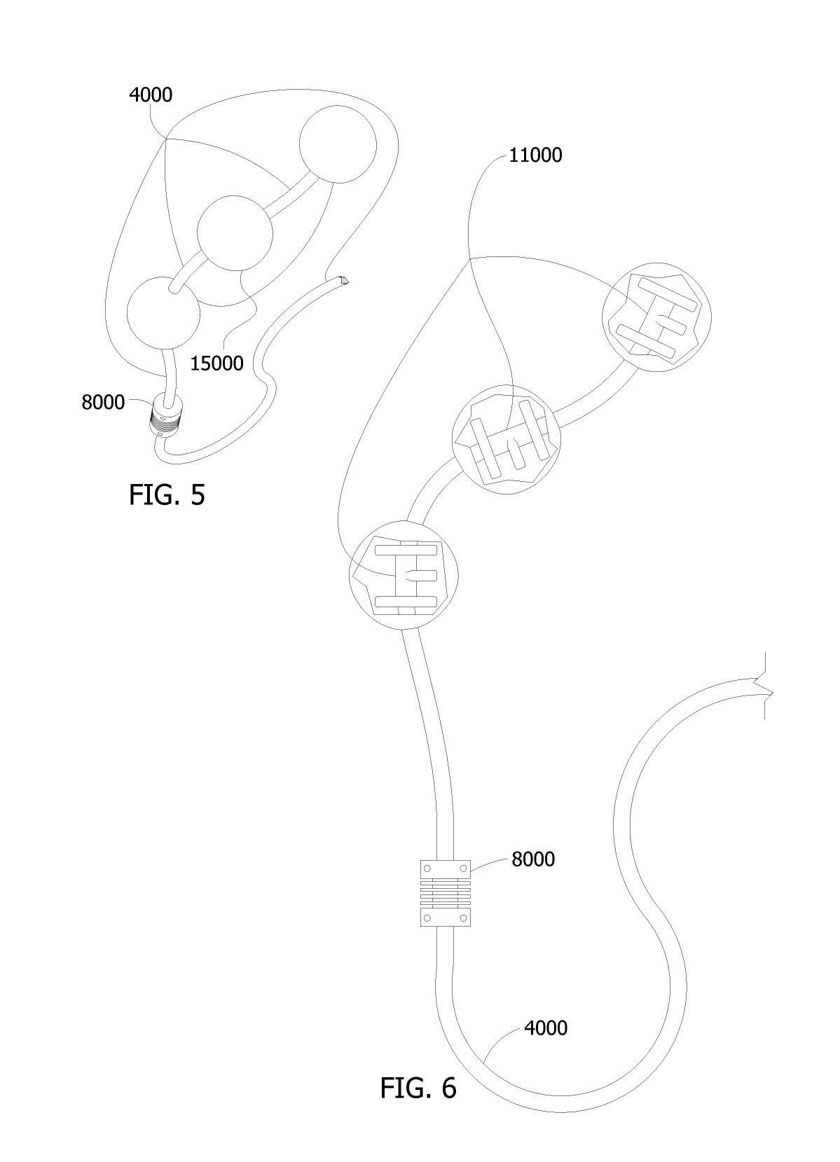

FIG. 5 shows an exemplary “ben wa” ball attachment 15000 wherein each ball contains is driven by the long flexible driveshaft 4000. In some embodiments, the “ben wa” balls vibrate, rotate and have other effects driven by the rotating core of the flexible driveshaft 4000.

FIG. 6 shows a cut away of one embodiment of such attachment where each ball operates on an unbalanced mechanism 11000. Anti-vibration grip 8000 is located where the applicator is attached. The attachment mechanism may be magnetic, mechanical or otherwise. The grip and/or attachment mechanisms may also and alternatively be located on different and/or multiple parts of the invention such as the applicator head, base unit and flexible driveshaft.

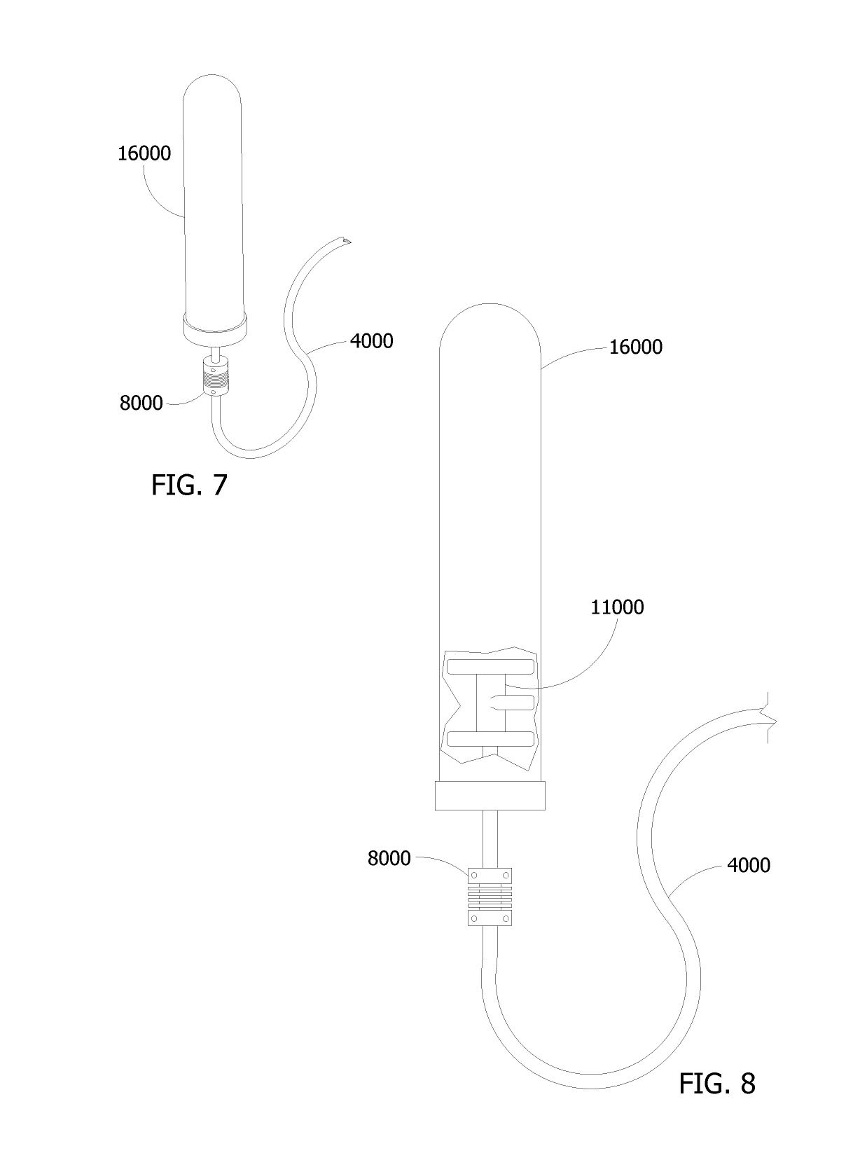

FIG. 7 shows a phallic attachment 16000. FIG. 7 is for illustrational purposes, various shapes and forms of dong are able to be substituted. Although the applicator grip 8000 is shown separate from the phallic attachment it may also be part of that attachment. As show, the interior parts of the phallic attachment are driven by the core of the flexible driveshaft 4000.

FIG. 8 shows a cutaway of the phallic attachment 16000 of FIG. 7. In this example an unbalance mechanism 11000 is directly driven by the core of the driveshaft 4000. However, as in other applicator modules, the unbalance and/or other mechanisms may also be indirectly driven by the core through the use of gears, springs, generators etc. It is preferred to have an anti-vibration grip. In or near this grip it is preferred to have an attachment mechanism to provide attachment/detachment of additional driveshafts and/or additional/alternative applicator modules. Attachment mechanisms may include amongst magnets, sockets, clamps, glues, hooks, loops, pins, clamps, screws, etc.

In addition to phallic, rabbit ear, and “ben wa” ball attachments other instruments of varying shape, function and form are connected and driven by the driveshaft in the base. These other instruments and attachment are combinations of the above and/or also include other variations such as penile sleeves, vaginal simulators, anal simulators, vaginal stimulators, anal stimulators, vacuums, suction devices, rotating rings and others. These various instruments and attachments are operated by the driveshaft and/or gears and other mechanical devices. In some embodiments, electrical current is further provided by a circuit within and/or parallel to the driveshaft or through other power sources contained within the applicator module, head or grip. The alternative power sources drive other electromechanical processes, including electro thermal processes and audio and visual effects (e.g. heating, cooling, LEDs, lasers, music and sound).

The vibrating mechanisms in the applicator modules typically use brushed or brushless eccentric rotating mass (ERM) mechanisms and linear resonant actuators (LRA). However, an advantage of the invention is separating the motor and applicator module through the use of an extended driveshaft. Consequently, although an ERM mechanism and electrical circuit could be placed in an applicator module, the invention still functions without a corresponding motor in the applicator module. However, some applicator modules use generators and/or transformers to change the mechanical energy provided from the driveshaft to power other thermal, mechanical and electrical processes. In some instances ERM and LRA mechanisms may be interchangeable and/or operated in tandem. In some applications capacitors are charged through the drive shaft. This can be done through induction and other known and soon to be discovered processes.

When using ERM mechanisms frequency is typically measured in revolutions per minute or hertz. The total vibration amplitude can be calculated from F=mass times acceleration, where F (i.e. centripetal force in Newtons) is generally equal to mass of the eccentric mass times eccentricity of the eccentric mass times the angular velocity (omega) squared.

The invention enables the electrical energy system to be isolated in the base unit 1000 further from the applicator head so that the machine may operate on more powerful current and longer lasting batteries without weighing down the applicator heads and reducing interfering vibrations at the site of personal application.

Having thus described preferred embodiments, it should be apparent to those skilled in the art that certain advantages of the described system have been achieved. It should also be appreciated that various modifications, adaptions, and alternative embodiments thereof may be made within the scope and spirit of the present invention. The invention is further defined by the following claims.

What I claim is:

1. A driveshaft personal massager, comprising:
a base unit; and,
an extended driveshaft wherein the extended driveshaft is longer than 6 inches.

2. The driveshaft personal massager recited in claim 1, wherein said extended driveshaft is flexible.

3. The driveshaft personal massager recited in claim 1, wherein said extended driveshaft is greater than two feet long.

4. The driveshaft personal massager recited in claim 3, wherein said extended driveshaft is detachably coupled to an applicator module.

5. The driveshaft personal massager recited in claim 3, wherein said applicator module comprises at least one unbalanced mass which is connectively associated with the rotational force of the extended driveshaft.

6. The driveshaft personal massager recited in claim 5, wherein said applicator module comprises more than one unbalanced mass connectively associated with the rotational force of the extended driveshaft

7. The driveshaft personal massager recited in claim 5 wherein the base unit contains an electrical motor.

8. The driveshaft personal massager recited in claim 7 wherein the electrical motor is connectively associated with a power storage device within the base unit.

9. The driveshaft personal massager recited in claim 8 wherein the frequency of rotations of the electrical motor is adjustable.

10. The driveshaft personal massager recited in claim 9 wherein the extend driveshaft is surrounded by an outer covering that insulates vibrations.

11. The driveshaft personal massager recited in claim 10 wherein the massager further comprises an anti-vibration grip.

12. The driveshaft personal massager recited in claim 11 wherein the anti-vibration grip houses controls that adjust one or more of: frequency, amplitude, or temperature.

13. The driveshaft personal massager recited in claim 12 wherein the anti-vibration grip contains a communication circuit for receiving electromagnetic signals to adjust one or more of: frequency, amplitude, or temperature.

14. The driveshaft personal massager recited in claim 12 wherein the base unit contains a communication circuit for receiving electromagnetic signals to adjust one or more of: frequency, amplitude, or temperature.

15. A method of massage wherein a motor contained in a base unit is connectively associated with an applicator module by an extended driveshaft.

16. The method of massage in claim 15 wherein the base unit contains a power storage unit.

17. The method of massage in claim 16 wherein the extended driveshaft rotates an unbalanced mass contained within the applicator module.

18. The method of massage in claim 17 wherein the frequency of rotation of the extended driveshaft is adjusted by user controls housed in an anti-vibration grip that surrounds the extended driveshaft.

19. The method of massage in claim 17 wherein the frequency of rotation of the extended driveshaft is adjusted upon electromagnetic communication to a transceiver in the base unit.

20. The method of massage in claim 18 wherein the frequency of rotation of the extended driveshaft is adjusted upon electromagnetic communication to a transceiver housed in the anti-vibration grip.
